(19) United States
(12) Patent Application Publication
(10) Pub. No.: US 2008/0105196 A1
(43) Pub. Date: May 8, 2008

(54) METERING AND/OR LEVELING DEVICE

(76) Inventors: Jochen Meinel, Heidenheim (DE); Franz Fischer, Sontheim (DE)

Correspondence Address: Todd T. Taylor;Taylor & Aust, P.C., 142 S. Main Street, P.O. Box 560, Avilla, IN, 46710, US

(21) Appl. No.: 11/959,674

(22) Filed: Dec. 19, 2007

Related U.S. Application Data
(63) Continuation of application No. PCT/EP2006/060247, filed on Feb. 24, 2006.

(30) Foreign Application Priority Data
Jun. 23, 2005 (DE) 10 2005 029 613.0

(51) Int. Cl. B05C 11/04

(52) U.S. Cl. 118/123

(57) ABSTRACT

A device for metering and/or leveling a liquid to pasty medium applied to a moving surface, the surface in the case of direct application of the medium being a paper, board or other fibrous web and in the case of indirect application being the surface of a transfer element, for example an applicator roll, which transfers the application medium to the surface of the fibrous web, including a retaining body for holding a doctor element and a pressure element, the retaining body being set against the moving surface and the pressure element pressing the top part of the doctor element against the moving surface for the purpose of metering and/or leveling the applied medium; a clamping hose to which pressure can be applied and which therefore executes a displacement travel and which, when pressurized, presses the bottom part of the doctor element against a supporting bar of the retaining body and clamps said doctor element in and, when the pressure is relieved, releases the doctor element; and an additional retaining bar to hold the clamping hose, is arranged parallel to the supporting bar and is accommodated detachably in the retaining body, and the retaining bar having at least one projection toward the supporting bar, which projection projects in a distance beyond the minimum displacement travel of the clamping hose, so that a gap remains with respect to the supporting bar.

### CROSS REFERENCE TO RELATED APPLICATIONS

This is a continuation of PCT application No. PCT/EP2006/060247, entitled “DOSING AND/OR LEVELLING DEVICE”, filed Feb. 24, 2006, which is incorporated herein by reference.

### BACKGROUND OF THE INVENTION

1. Field of the Invention

The invention relates to a device for metering and/or leveling a liquid to pasty medium applied to a moving surface, the surface in the case of direct application of the medium being a paper, board or other fibrous web and in the case of indirect application being the surface of a transfer element, for example an applicator roll, which transfers the application medium to the surface of the fibrous web.

2. Description of the Related Art

The device includes a retaining body for holding a doctor element and a pressure element, the retaining body being set against the moving surface and the pressure element pressing the top part of the doctor element against the moving surface for the purpose of metering and/or leveling the applied medium.

The device further includes a clamping hose to which pressure can be applied and which therefore executes a displacement and which, when pressurized, presses the bottom part of the doctor element against a supporting bar of the retaining body and clamps said doctor element in and, when the pressure is relieved, releases the doctor element.

Devices of this type are already known from DE-U 9416951, U.S. Pat. No. 5,738,724 A and also WO 2004/052562 A1.

In these documents, it is also described and shown that a doctor blade or a metering rod fitted to a blade are able to form the doctor element and therefore, as already explained above, this blade can be clamped into the doctor holder with the clamping hose. In this case, the clamping hose is inserted into a groove. The groove itself is either machined directly into the doctor holder or there is a bar which is in turn firmly connected to the doctor holder and the groove is let into this bar.

The disadvantage with these embodiments is that, firstly, the doctor holder has a relatively complicated configuration as a result, which accordingly can be produced only with a great deal of effort and, secondly, it is disadvantageous that the clamping hose has to remain in the doctor holder during the cleaning of the device. Otherwise, all the adjacent device components would have to be removed individually, which means an enormous amount of time and therefore stoppage times and production loss.

In order to ensure halfway good accessibility during the cleaning or during a necessary hose change or when pulling the doctor element in, in the prior art the displacement travel of the clamping hose is normally chosen to be large. This means that the groove also has to be dimensioned to be correspondingly large, as a result of which, although it is better accessible for service and cleaning purposes, the doctor element or the doctor blade is guided poorly as it is pulled into the device. In other words, on account of the great amount of space that is present, the bottom part of the blade is set obliquely and, as a result, can damage the clamping hose with its bottom end by way of cuts or the like, so that it no longer fulfills its function.

In addition, the space available within the device for service and cleaning purposes is nevertheless very limited.

Overall, the mounting and disassembly is complicated and complex and gives rise to high costs.

What is needed in the art is an improved metering and/or leveling device with which the disadvantages of the prior art can be avoided.

### SUMMARY OF THE INVENTION

The present invention provides a device for metering and/or leveling a liquid to pasty medium applied to a moving surface, the surface in the case of direct application of the medium being a paper, board or other fibrous web and in the case of indirect application being the surface of a transfer element, for example an applicator roll, which transfers the application medium to the surface of the fibrous web, including a retaining body for holding a doctor element and a pressure element, the retaining body being set against the moving surface and the pressure element pressing the top part of the doctor element against the moving surface for the purpose of metering and/or leveling the applied medium. The device further includes a clamping hose to which pressure can be applied and which therefore executes a displacement travel (w) and which, when pressurized, presses the bottom part of the doctor element against a supporting bar of the retaining body and clamps said doctor element in and, when the pressure is relieved, releases the doctor element. The device further includes an additional retaining bar to hold the clamping hose, the retaining bar being arranged parallel to the supporting bar and being accommodated detachably in the retaining body, the retaining bar having at least one projection toward the supporting bar, which projection projects in a distance (a) beyond the minimum displacement travel (w) of the clamping hose, so that a gap (s) remains with respect to the supporting bar.

Accordingly, the invention provides for an additional retaining bar to be arranged to hold the clamping hose.

The retaining bar is accommodated in a groove in the retaining body and arranged parallel to the supporting bar.

The retaining bar is fitted or arranged detachably in such a way that, together with the clamping hose inserted into it, it can be removed from the device in a simple way, cleaned or replaced and inserted again. Thus, for example, a hose change is possible much more quickly and simply than hitherto and lasts only about 2 minutes.

One important feature of the invention is that the retaining bar is equipped with projections toward the supporting bar or toward the doctor element clamped in, which projections project beyond the minimum displacement travel of the clamping hose inserted into the groove in the retaining bar.

This ensures that, when the doctor element is being pulled in, the latter is not able to be displaced substantially or set obliquely and damage the clamping hose.

The term doctor element within the scope of the invention should be understood to mean a very thin and sharp-edged doctor blade but also such a flexible blade element, to which a metering rod mounted in a doctor bed is fitted. However, a doctor element is also to be understood as a metering rod whose doctor bed has an integrally molded base bar and whose bottom part is to be clamped into the doctor holder.

It is to be viewed as an advantage of the invention that the retaining bar, including the clamping hose to which pressure or compressed air can be applied, can be withdrawn from and inserted into the retaining body completely, laterally or else upward, by hand in a straightforward manner. It goes without saying that the clamping hose is vented during withdrawal or insertion.

The space created when the retaining bar is withdrawn is now larger as a result and better accessible for intended service and cleaning work on the doctor holder. In addition, the retaining bar together with clamping hose is better accessible when withdrawn, so that, as a result, a hose change proceeds substantially more quickly, since it is now carried out outside the doctor device. As a result, production losses during the production and/or finishing of a fibrous web are reduced.

The cleaning effort can be reduced if the retaining bar is fabricated from plastic or is at least partly coated with a contamination-repellent material, such as Teflon. In addition, a retaining bar fabricated from plastic is light and, as a result, can be handled particularly well.

One expedient solution can consist in the retaining bar being retained in the retaining body via an inflatable tightening hose likewise let into it.

The connection to the retaining body can also be made via a form-fitting connection, for example by hooking in, clamping in or pushing in, for example a construction in accordance with the tongue and groove principle.

As a result, the removal from or separation from the retaining body (for example doctor beam or supporting beam) is very simple.

The retaining bar can be fabricated from a flexible or a rigid material.

A further advantageous solution consists in the clamping hose having only a small displacement or displacement travel. As a result, the space required is smaller. In addition, the hose itself is less unstable with a smaller displacement, but the doctor element or the blade can also be guided better in the holder as a result.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a metering and/or leveling device according to the invention, illustrated in section in side view, with a retaining bar according to the invention and doctor element clamped in;

FIG. 2 shows the device according to FIG. 1 with the retaining bar taken out;

FIG. 3 shows the device according to FIG. 1 with the clamping hose depressurized;

FIG. 4 shows a first variant of the arrangement of the retaining bar; and

FIG. 5 shows a second variant of the arrangement of the retaining bar.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

Referring now to the drawings, there is shown all the components shown in section of the metering and/or leveling device 1 for a liquid to pasty medium M applied to a moving surface 2 extend over the full width of the device, which in turn corresponds at least to the web width of the fibrous web to be treated.

In the individual figures, identical components are provided with the same designation.

The moving surface 2 in the case of direct application of the medium, for example coating color, size, starch, is a paper, board or other fibrous web and in the case of indirect application is the surface of a transfer element, for example an applicator roll, the transfer element transferring the application medium to the surface of the fibrous web.

The device 1 illustrated in FIG. 1 has a retaining body 3 (which can also be designated a doctor beam or supporting body). This retaining body 3 is used to hold a doctor element 4 and a pressure element 5, the retaining body 3 being set against the surface 2 moving in the running direction L. The pressure element 5 in the example is a hose to which compressed air can be applied and which presses the top part 4.1 of the doctor element 4 against the moving surface 2 for the purpose of metering and/or leveling the previously applied medium M.

The magnitude of the pressing pressure in the direction of the arrow F of the doctor element 4 is selected depending on how much of the application medium M in g/m² is to be doctored off or whether only leveling of the applied medium M is to be carried out. For this purpose, use is made of an adjusting device, substantially including an adjusting spindle and pressure bar, this adjusting device being designated generally by 6.

In the example, the doctor element 4 illustrated is a flexible blade, whose blade tip is pressed against the moving surface 2.

The device 1 additionally includes a second hose to which pressure can be applied and which therefore executes a displacement, namely a clamping hose 7 which, when inflated, that is to say under pressure, presses the bottom part 4.2 of the doctor element 4 against a supporting bar 8 or stop on the retaining body 3. As a result, the doctor element 4 or the blade is clamped in. When the pressure is relieved, the doctor element 4 is released and can be removed or replaced.

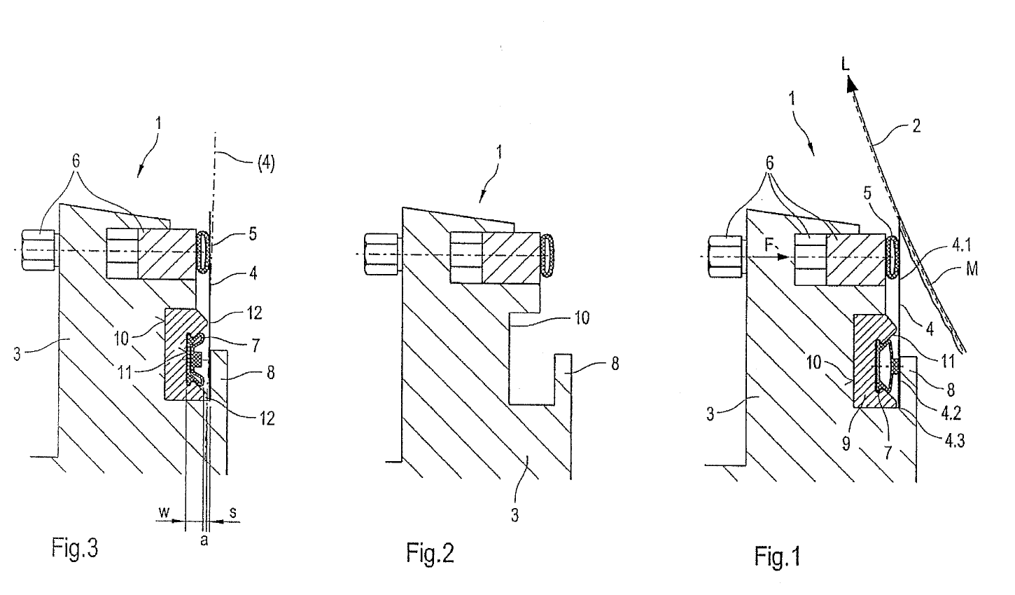

In order that the clamping hose 7 can also be replaced better and more quickly and can also be cleaned, an additional retaining bar 9 is let into the retaining body 3. For this purpose, the retaining bar 9 is pushed into a groove 10 and can easily be withdrawn from the latter. As shown in FIG. 2, following the withdrawal of the retaining bar 9 there is sufficient space available for cleaning purposes of the doctor holder and the groove 10.

The retaining bar itself accommodates the clamping hose 7 in a trapezoidally configured groove 11 (instead of the retaining body 3 or the doctor beam as hitherto), as can be seen in FIGS. 1 and 3. The retaining bar 9 is arranged parallel to or behind the supporting bar 8 in such a way that, in the inflated state of the clamping hose 7 located in the retaining bar 9 (FIG. 1), it clamps the doctor element 4 in the retaining body.

In order that the clamping hose 7 is not damaged by the underside 4.3 of the blade during insertion into the device 1 or withdrawal of the doctor element 4 from the device 1, the retaining bar 9 has projections 12 starting from its groove 11 on both sides and pointing toward the doctor element or blade 4 and toward the supporting bar 8. These projections, but at least the lower projection 12, project beyond the minimum displacement travel w of the clamping hose 7 by a distance a (about 1.5 mm). In this case, there also remains a gap s that is only small (about 3 mm) from the supporting bar 8. This ensures that a new blade 4 is guided better during insertion into the device or a worn or damaged blade 4 is guided better as it is withdrawn from the device. In this case, it is advantageous that this blade 4 strikes at least this lower projection 12 instead of, as hitherto, making contact with the clamping hose 7 and damaging it.

When the clamping hose 7 is not loaded, which is to say during the insertion or withdrawal of the blade 4 (see FIG. 3), the latter therefore assumes a position which is only slightly oblique and virtually vertical, as illustrated in FIG. 3 by a dash-dotted line.

In the examples, in each case a commercially available nose hose consisting of rubber or rubber-reinforced material or silicone or natural rubber or the like is illustrated. However, it would also be possible to use a commercially available profiled hose (like the pressure hose 5) or a commercially available round hose (like the tightening hose 13).

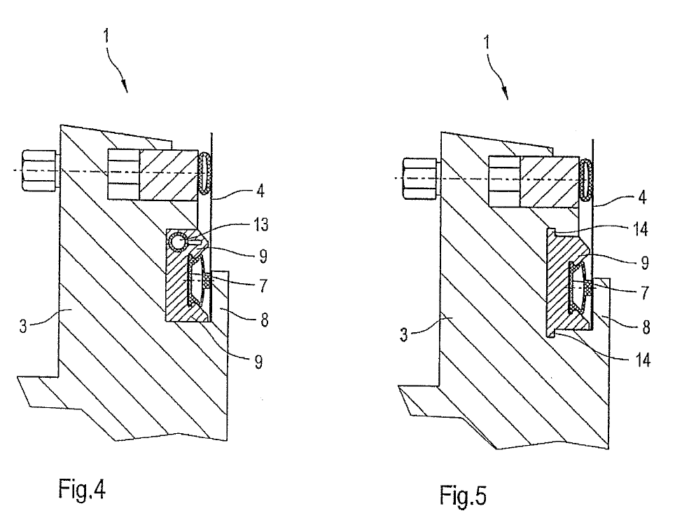

It should be added that the retaining bar 9 can be fitted detachably to the retaining body 3 by using a tightening hose 13 (see FIG. 4) or by way of a form-fitting connection 14 (see FIG. 5), for example by way of hook-in parts, clips, or sliding elements such as a tongue and groove connection and the like. The connections shown can be detached easily and thus also permit the retaining bar 3 with embedded clamping hose 7 to be replaced quickly.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF DESIGNATIONS

1 Device
2 Moving surface
3 Retaining body
4 Doctor element
4.1 Top part
4.2 Bottom part
5 Pressure element
6 Adjusting device
7 Clamping hose
8 Supporting bar
9 Retaining bar
10 Groove
11 Groove
12 Projection
13 Tightening hose
14 Form-fitting connection
F Pressing force
M Application medium
w Displacement travel
a Distance
s Gap

What is claimed is:

1. A device for at least one of metering and leveling a liquid to pasty medium applied to a moving surface, the moving surface in a case of direct application of the medium being a web of fibrous material and in a case of indirect application being a surface of a transfer element which transfers the medium to a surface of the web, said device comprising:
a doctor element including a top part and a bottom part;
a pressure element;
a retaining body including a supporting bar, said retaining body for holding said doctor element and said pressure element, said retaining body being set against the moving surface, said pressure element pressing said top part of said doctor element against the moving surface for at least one of metering and leveling the medium applied to the moving surface;
a clamping hose to which pressure can be applied and configured for executing a displacement travel, said clamping hose, when pressurized, pressing said bottom part of said doctor element against said supporting bar of said retaining body and clamping said doctor element in, said clamping hose, when depressurized, releasing said doctor element; and
a retaining bar for holding said clamping hose, said retaining bar being arranged parallel to said supporting bar and accommodated detachably in said retaining body, said retaining bar having at least one projection toward said supporting bar, said at least one projection projecting in a distance beyond a minimum displacement travel of said clamping hose so that a gap remains with respect to said supporting bar.

2. The device as claimed in claim 1, wherein said retaining bar is configured for being withdrawn from and inserted into said retaining body together with said clamping hose.

3. The device as claimed in claim 1, wherein said retaining bar one of includes a plastic and is at least partly coated with a contamination-repellent material.

4. The device as claimed in claim 3, wherein said contamination-repellent material is Teflon.

5. The device as claimed in claim 1, wherein said retaining bar is detachably connected to said retaining body via one of a tightening hose and a form-fitting connection.

6. The device as claimed in claim 5, wherein said form-fitting connection includes at least one of a hooking in, a clamping in, and a pushing in.

7. The device as claimed in claim 1, wherein said retaining bar includes one of a flexible and a rigid material.

8. The device as claimed in claim 7, wherein said clamping hose is one of a commercially available round, profiled, and nose hose including one of a rubber material, a rubber-reinforced material, a silicone, and a natural rubber and has one of only a small displacement and said displacement travel.
